(19) United States
(12) Patent Application Publication
(10) Pub. No.: US 2006/0196503 A1
(43) Pub. Date: Sep. 7, 2006

(54) Protective shield, and protective equipment including such a shield and a storage box

(76) Inventor: Michel Bardel, Maurepas (FR)

Correspondence Address: JOHN S. PRATT, ESQ;KILPATRICK STOCKTON, LLP, 1100 PEACHTREE STREET, ATLANTA, GA, 30309, US

(21) Appl. No.: 10/552,130

(22) PCT Filed: Apr. 5, 2004
(86) PCT No.: PCT/EP04/04261

§ 371 Date: Oct. 5, 2005

(30) Foreign Application Priority Data
Apr. 10, 2003 (FR) 03/04503

(51) Int. Cl. A62B 18/00; A62B 17/04

(52) U.S. Cl. 128/201.24

(57) ABSTRACT

A protective shield (1) for protecting the eyes against smoke, the shield being adapted to be placed over the upper portion of the face of a user around the eyes. The shield (1) includes locking means (2) adapted to fix the shield in temporary manner on a face mask (3) such as a mask for supplying breathing gas to an aircraft flight crew member. The shield (1) also includes a display device (5) adapted to enable a user whose face is covered by the shield (1) to view information in the user's field of view, in particular information for providing assistance in flying.

The present invention relates to equipment in particular for the flight crew of aircraft, equipment such as protective shields, face masks, and storage boxes for such shields and/or masks.

More particularly, in one aspect, the invention relates to a protective shield for protecting the eyes against smoke and adapted to be applied to the upper portion of the face of a user around the eyes, and including locking means suitable for temporarily fixing it to a face mask such as a mask for supplying breathing gas to an aircraft flight crew member.

Document U.S. Pat. No. 5,630,412 describes an example of equipment comprising a mask and a shield as mentioned above. In that equipment, the shield is adapted to be capable of being mounted quickly and releasably on the mask, in particular when the mask is already in place on a user's face. In aviation, for example, regulations can require that pilots and co-pilots of transport airplanes wear equipment to provide protection against hypoxia continuously under certain flying conditions, and in particular at very high altitude or when only one pilot is present in the cockpit. In order to provide protection against smoke and/or toxic or irrigating gas coming into contact with the eyes, the user may need to wear a shield in addition to the mask which is already in place.

In the presence of smoke, in particular, visibility in the cockpit is reduced and information that is of use to the flight crew and that is generally displayed on the control panel might no longer be visible.

A particular object of the present invention is to give access to information and in particular information for providing assistance in flying.

To this end, the invention provides a shield which, in addition to the characteristics mentioned above, is characterized by the fact that it includes a display device adapted to enable a user whose face is covered by the shield to view information in the user's field of view, said information serving in particular to provide assistance in flying.

By means of these dispositions, the user can with a single action and in a few seconds don both a shield which will provide protection against smoke and a device enabling the user to view information needed to continue the user's activity, even when the display devices on the control panel are no longer visible.

In embodiments of the invention, recourse may optionally also be had to one or more of the following dispositions:

the display device is placed outside the shield when the shield is covering the face of the user; this disposition is particularly advantageous when it is desired to have a display device that is releasably mounted on the shield; thus, a user already wearing protective equipment comprising a mask and a shield, e.g. to provide protection against toxic gas, can in the event of smoke occurring or thickening act to don the display device without removing the protective equipment; similarly, a user already wearing protective equipment comprising a mask and a shield fitted with a display device can detach the display device from the shield without removing the protective equipment, on dissipation of the smoke that once required the use of the display device;

the display device includes light transmission means disposed inside the shield when the shield is covering the face of the user; this disposition is particularly useful when it is desired to protect the display device from ambient smoke; because of the small positive pressure of the breathing gas that exists under the shield, and because of the volume situated under said shield is swept by a breathing gas, the display device and more particularly its optical elements, are maintained in a very good state of cleanliness, avoiding any polluting deposit therein; and

the display device is a device for projecting a light signal on the user's retina.

In another aspect, the invention relates to protective equipment for the head, in particular for aircraft flight crew, the equipment comprising:

a face mask adapted to be applied in use to the lower portion of the face of a user around the user's nose and mouth, and to supply the user with breathing gas; and

a protective shield for protecting the eyes and adapted to be applied to the upper portion of the user's face around the eyes, and including locking means adapted to fix the shield on the face mask in temporary manner;

the equipment being characterized by the fact that it includes a display device adapted to enable the user whose face is covered by the shield to view information in the user's field of view, in particular information for providing assistance in flying.

This equipment optionally further comprises connection means adapted for transmitting information from the mask to the display device.

In yet another aspect, the invention relates to a storage box adapted to receive a protective shield as mentioned above, i.e. a shield fitted with a device for displaying information.

In embodiments of the storage box of the invention, recourse may optionally also be had to one or more of the following dispositions:

the box includes a light transmission system adapted to convey a light signal from the display device out from the storage box, thereby constituting a light signal that is visible to a user without it being necessary for the user to extract the shield from the storage box; and

the box includes connection means for the display device to transmit information from the storage box to the shield or to a face mask when the mask is placed on the face of the user.

Other aspects, objects, and advantages of the invention appear on reading the following description of various embodiments thereof.

The invention will also be understood with the help of the drawings, in which:

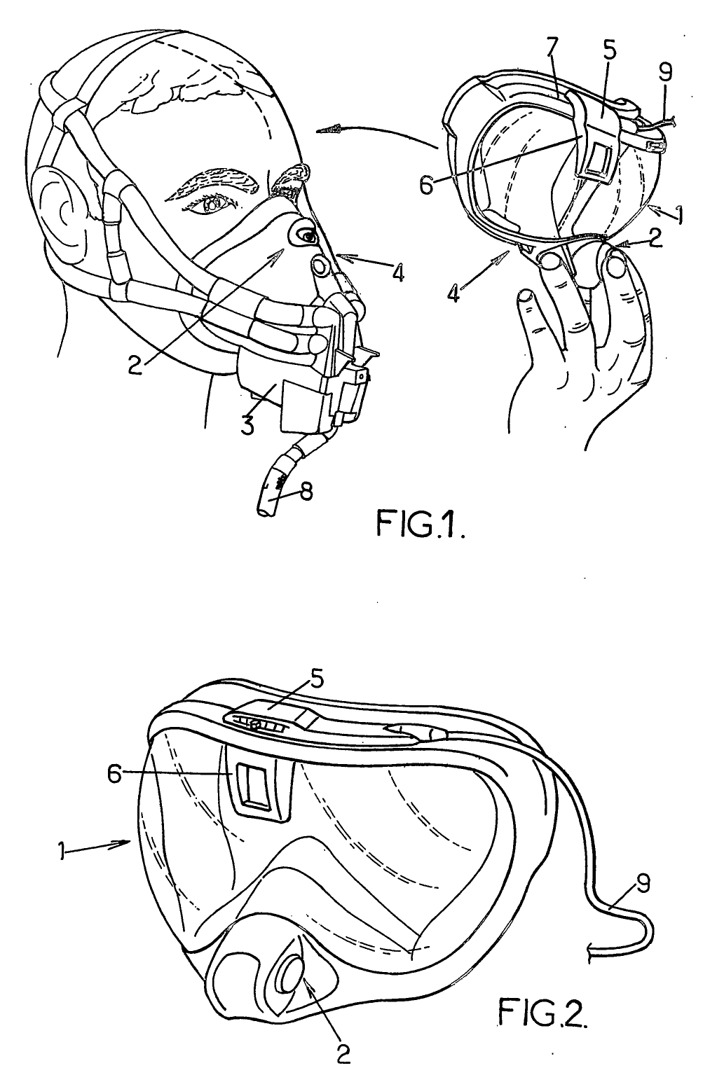

FIG. 1 is a diagrammatic perspective view of an equipment of protective equipment of the invention in which the display device is disposed outside the shield when the shield covers the face of the user;

FIG. 2 is a diagrammatic perspective view of a protective shield of the invention provided with a display device including light transmission means disposed inside the shield;

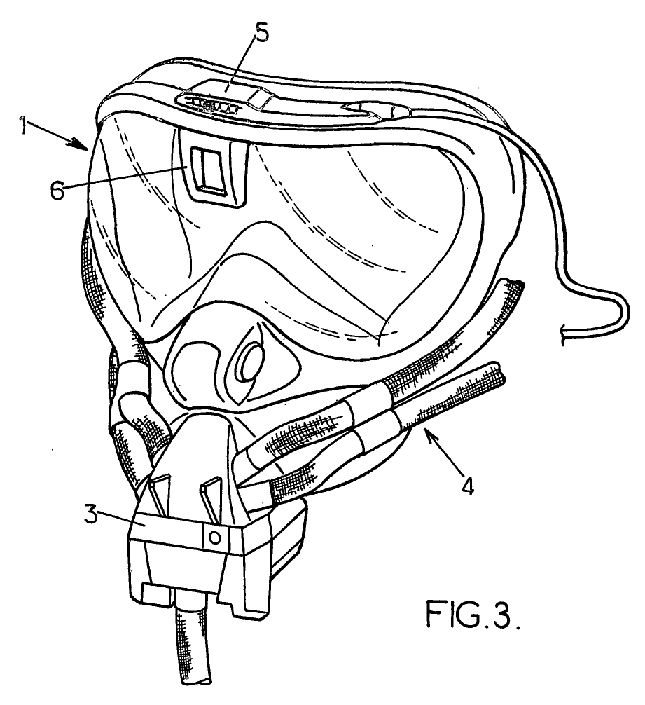

FIG. 3 is a diagrammatic perspective view of protective equipment of the invention of the kind shown in FIG. 1, in which the protective shield is attached to a face mask;

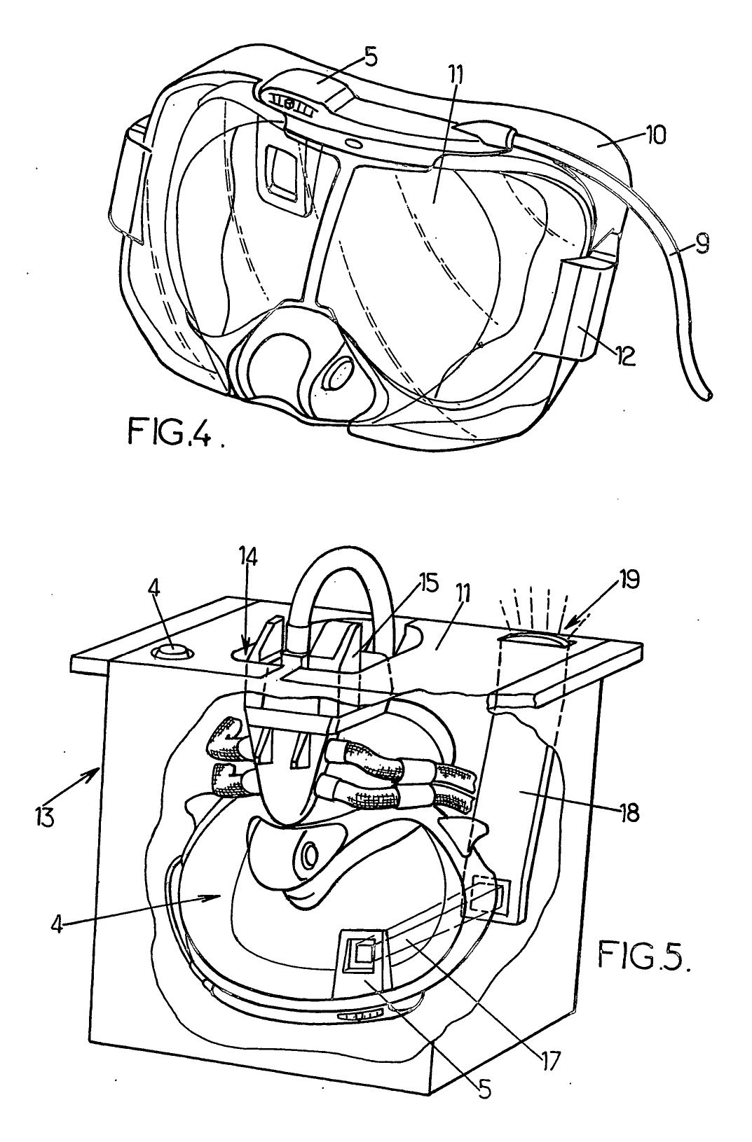

FIG. 4 is a diagrammatic perspective view of a storage box adapted to receive a protective shield of the kind shown in FIGS. 1 to 3; and

FIG. 5 is a partially cutaway diagrammatic perspective view of a storage box for equipment of the kind shown in FIG. 3.

In the figures, the same references are used to designate elements that are identical or similar.

In a first embodiment, shown in FIG. 1, the invention relates to a protective shield 1 for protecting the eyes of a user against smoke or other toxic and/or irritating gases.

This shield 1 has locking means 2 adapted for fixing in temporary manner to a face mask 3.

The shield 1 and the face mask 3 constitute protective equipment 4. This type of protective equipment 4 can be used in particular by the flight crew of aircraft.

The shield 1, the face mask 3, and the locking means 2 are of a general structure that is already known, being described in particular in the patent applications filed under the Nos. FR 94/01159 and FR 02/07090.

In accordance with the invention, the protective shield 1 is provided with a device 5 for displaying information such as information providing assistance in flying.

In a first equipment, the display device 5 is disposed outside the shield 1 when the shield is in place on the face of a user.

By way of example, the display device 5 can be a known device such as one of those sold by the supplier Microvision, Inc., based in Bothell in the state of Washington, USA. Under such circumstances, the display device 5 projects the information in the form of light signals onto the retina of the user by optical transmission means 6 such as mirrors and/or other optical components.

The display device 5 may be removably mounted on the shield 1. Under such circumstances, not only can the face mask 3 be used independently of the shield 1, but also the shield 1 and the face mask 3 can be used independently of the display device 5.

In FIG. 1, the display device is shown having connection means 9 enabling images supplied by a video device (not shown) to be transmitted to the display device 5.

In a variant that is not shown, the connection means pass via the frame 7 of the shield to a connector situated on the shield 1, serving to co-operate with a complementary connector situated on the face mask 3. The face mask 3 is connected to a video system via cabling that is connected to the feed pipe 8 feeding the face mask 3 with breathing gas.

In yet another variant, the display device 5 operates independently and the connection means 9 are not required.

Thus, in the latter two variants, the user is not encumbered by cabling in addition to that which is required to enable the face mask 3 to operate.

In a second embodiment, shown in FIG. 2, the shield 1 is provided with a display device 5 in which the light transmission means 6 are disposed inside the shield 1 when the shield 1 is covering the face of a user. The same characteristics and the same variants as in the first embodiment can be applied to this second embodiment.

FIG. 3 shows protective equipment 4 comprising a face mask 3 having a shield 1 removably mounted thereon by locking means 2, the shield 1 itself including a display device 5.

As shown in FIG. 4, the shield 1 can be stored in a stand box 10. This type of box is already described in the patent application filed under the No. FR 02/16582. Thus, the shield 1 can be stored within reach, in the stand box 10 with the display device 5 already connected. The display device 5 may be switched on merely by opening the doors 11, e.g. by a contact located in the hinges 12.

Another stand box may be provided for receiving a shield 1 provided with locking means but without a display device. Thus, the user can choose between a removable shield with or without a display device.

As shown in FIG. 5, the entire protective equipment 4 can be stored in a storage box 13. This box 13 is provided with two doors 11. Each door 11 includes a notch 14 coinciding with the notch in the other door. These notches 14 enable grip surfaces 15 of the face mask 3 to project outside the box 13. The display device 5 of the protective equipment 4 stored in the box 13 is already connected. It can be switched on by a contact when opening the doors 11. A test button 16 can also be disposed on the outside face of one of the doors 11. The test button 16 enables the display device 5 to be switched on temporarily. A light signal 17 is then emitted by the display device 5. This light signal 17 illuminates a light guide 18. The light guide 18 conveys at least a fraction of the light generated by the display device 5 to an end that constitutes a display 19. The display 19 is flush with one of the doors 11 via an opening formed therein. Thus, without extracting the protective equipment 4 from the box 13, the user can test operation of the display device 5.

Numerous variants of the embodiment of the invention described above can be envisaged without going beyond the ambit of the invention. Thus, the means for testing operation of the display device 5 such as those described with reference to FIG. 5 can be fitted to a stand box 10 of the kind described with reference to FIG. 4.

1. A protective shield for protecting the eyes against smoke and adapted to be applied to the upper portion of the face of a user around the eyes, and including locking means suitable for temporarily fixing it to a face mask such as a mask for supplying breathing gas to an aircraft flight crew member, the shield comprising a display device adapted to enable a user whose face is covered by the shield to view information in the user's field of view, said display device further comprising connection means enabling images to be supplied to said display device, said information serving in particular to provide assistance in flying.

2. A shield according to claim 1, in which the display device is placed outside the shield when the shield is covering the face of the user.

3. A shield according to claim 1, in which the display device includes light transmission means disposed inside the shield when the shield is covering the face of the user.

4. A shield according to claim 1, in which the display device is a device for projecting a light signal onto the retina.

5. A shield according to claim 1, in which the display device is removably mounted.

6. Head protection equipment, in particular for aircraft flight crew, the equipment comprising:
a face mask adapted to be applied in use to the lower portion of the face of a user around the user's nose and mouth, and to supply the user with breathing gas; and
a protective shield for protecting the eyes and adapted to be applied to the upper portion of the user's face around the eyes, and including locking means adapted to fix the shield on the face mask in temporary manner;
the equipment comprising a display device adapted to enable the user whose face is covered by the shield to view information in the user's field of view, in particular information for providing assistance in flying, said equipment further comprising connection means enabling images to be supplied to said display device via the feed pipe of said mask.

7. Equipment according to claim 6, including connection means adapted to transmit information from the mask to the display device.

8. A storage box adapted to receive a protective shield for protecting the eyes against smoke and adapted to be applied to the upper portion of the face of a user around the eyes, said protective shield including locking means suitable for temporarily fixing it to a face mask such as a mask for supplying breathing gas to an aircraft flight crew member, said shield further comprising a display device adapted to enable a user whose face is covered by the shield to view information in the user's field of view, said storage box further comprising a light transmission system adapted to convey a light signal from the display device out from the storage box, thereby constituting a light signal that is visible to a user without it being necessary for the user to extract the shield from the storage box.

9. A storage box according to claim 8, further adapted to receive said face mask with said protective shield.

10. A storage box according to claim 8, including connection means for the display device to transmit information from the storage box to the shield or to a face mask when the mask is placed on the face of the user.
